(19) United States
(12) Patent Application Publication
(10) Pub. No.: US 2012/0031247 A1
(43) Pub. Date: Feb. 9, 2012

(54) SAFE PUSHING DEVICE FOR TABLE SAWS

(76) Inventor: Tian Wang Wang, Taichung Hsien (TW)

(21) Appl. No.: 12/849,023

(22) Filed: Aug. 3, 2010

(51) Int. Cl. B27B 25/10

(52) U.S. Cl. 83/437.2

(57) ABSTRACT

A safe pushing device for table saws contains a sliding member fitted into a guide way of a fence so as to be pushed to slide in the guide way straightly; a seat fixed on the sliding member; a first axial arm including one side face axially coupled with the seat; a second axial arm including one side face axially connected with the seat; a retaining member axially connected with free ends of the first and the second axial arms; a handle member disposed on the second axial arm, such that the safe pushing device is capable of pushing the wood workpiece during a cutting process without using hands, thus obtaining a safety purpose.

### BACKGROUND OF THE INVENTION

1. Field of the Invention

The present invention relates to table saws, and more particularly to a safe pushing device for the table saws.

2. Description of the Prior Art

When cutting a wood workpiece on a table saw in the past, the user has to press the wood workpiece and pushes the wood workpiece toward a saw blade by hands, however such an operating method will cut the user's hands easily.

As shown in FIG. 1, to prevent the saw blade from cutting user's hands, an improved safe pushing device of table saws is developed and disclosed in U.S. Pat. No. 4,485,711, and includes a rack 1 and a retaining member 2 connected with the rack 1 by using screws. In operation, the rack 1 abuts against a fence 3 of the table saw, and the retaining member 2 is used to press a wood workpiece 4 so that the safe pushing device pushes the wood workpiece straightly, however, the safe pushing device is not coupled with the table saw, e.g., the safe pushing device is merely placed on the fence to be removed by the user easily or to be not used by the user, hence a safety function is lowered. In addition, when cutting various wood workpieces with different thickness, the retaining member 2 is adjusted toward a suitable height by rotating screws, having inconvenient operation.

Referring to FIG. 2, U.S. Pat. No. 5,341,711 discloses a conventional safety pushing device of table saws including a rack 5 and a retaining member 6 connected on the rack 5, and the retaining member 6 is capable of adjusting its height by rotating a screw 7 tightly or releasably, but such a conventional safety pushing device is not safe and not operated easily.

With reference to FIG. 3, a conventional safe pushing device of table saw disclosed in U.S. Pat. No. 4,603,612 includes a rack 8 contacted with a fence and a retaining member 9 coupled with the rack 8, between the retaining member 9 and the rack 8 is defined a spring 81 to abut the retaining member 9 against a wood workpiece and to adjust a height of the retaining member 9 so that the retaining member 9 allows to retain various wood workpieces with different thicknesses. Nevertheless, the spring 81 will generate a fatigue to decrease its abutting elasticity. Besides, the safe pushing device is fixed on the fence movably to be not used by the user, thus lowering safety.

As illustrated in FIG. 4, a safe pushing device disclosed in U.S. Pat. No. 5,662,019 is coupled with a fence without being removed easily to enhance safety, but a retaining member 91 is adjusted its height by rotating a screw 92 tightly or releasably, operating inconveniently.

The present invention has arisen to mitigate and/or obviate the afore-described disadvantages.

### SUMMARY OF THE INVENTION

The primary object of the present invention is to provide a safe pushing device for table saws that is capable of pushing the wood workpiece during a cutting process without using hands, thus obtaining a safety purpose.

Another object of the present invention is to provide a safe pushing device for table saws that when retaining various workpieces with different thickness, the handle member is pulled upward to actuate the first and the second axial arms, and the retaining member to move upward, and then the handle member is moved downward to actuate the first and the second axial arms, and the retaining member to move downward without rotating screws and nuts tightly or releasably, thus operating easily.

To obtain the above objective, a safe pushing device for table saws contains:

a sliding member fitted into a guide way of a fence so as to be pushed to slide in the guide way straightly;

a seat fixed on the sliding member;

a first axial arm including one side face axially coupled with the seat;

a second axial arm including one side face axially connected with the seat;

a retaining member axially connected with free ends of the first and the second axial arms;

a handle member disposed on the second axial arm.

### BRIEF DESCRIPTION OF THE DRAWINGS

FIG. 1 is a perspective view of a conventional safe pushing device of table saws disclosed in U.S. Pat. No. 4,485,711;

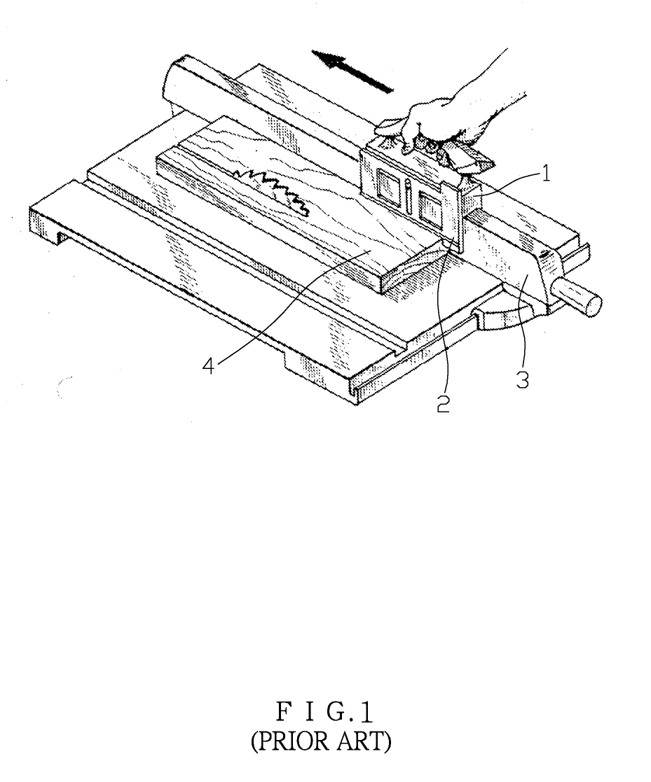

FIG. 2 is a perspective view of a conventional safe pushing device of table saws disclosed in U.S. Pat. No. 5,341,711;

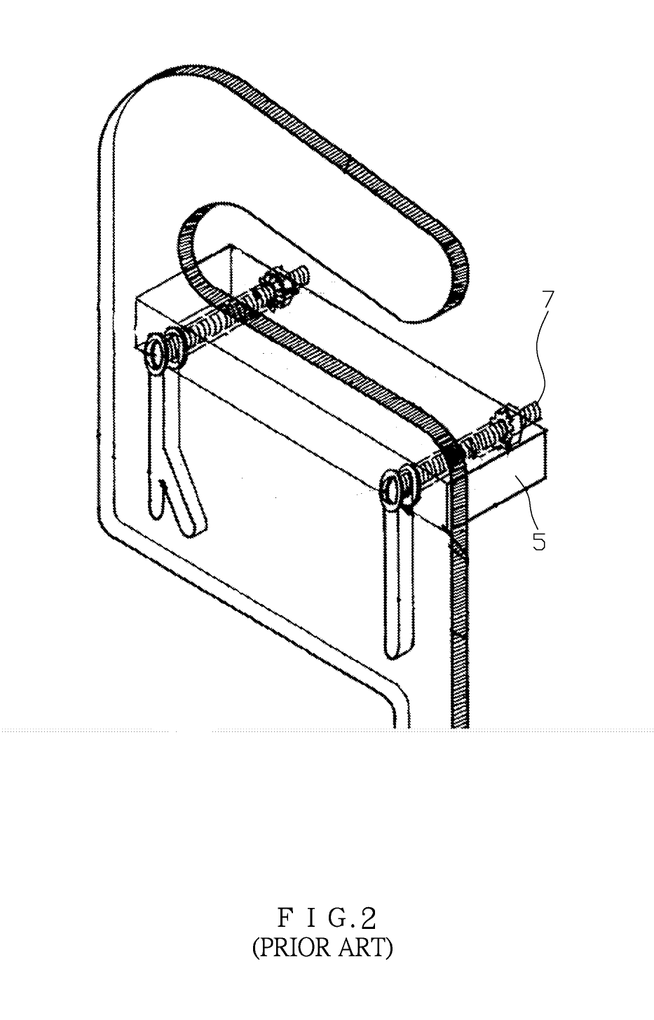

FIG. 3 is a perspective view of a conventional safe pushing device of table saws disclosed in U.S. Pat. No. 4,603,612;

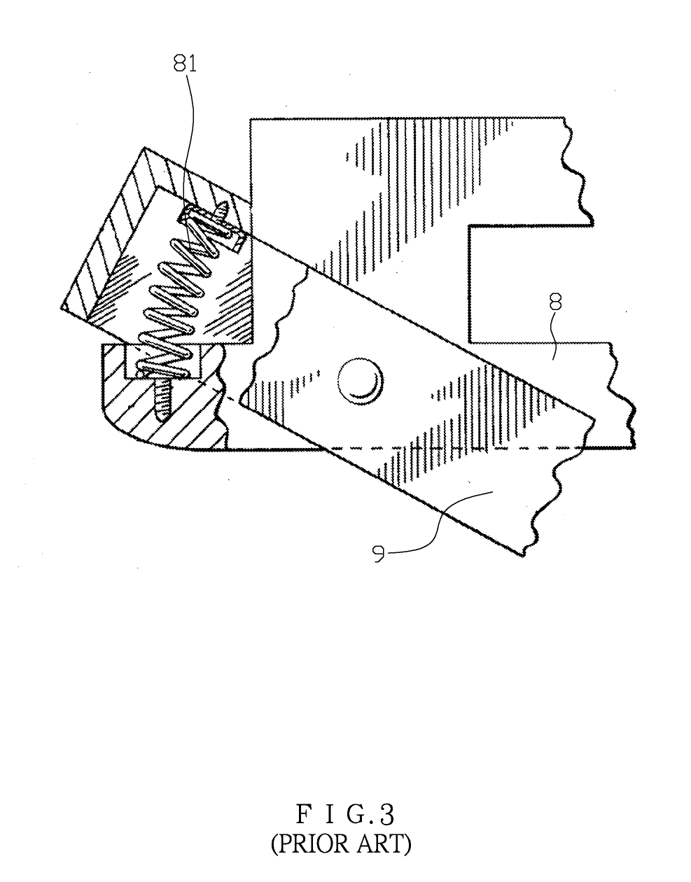

FIG. 4 is a perspective view of a conventional safe pushing device of table saws disclosed in U.S. Pat. No. 5,662,019;

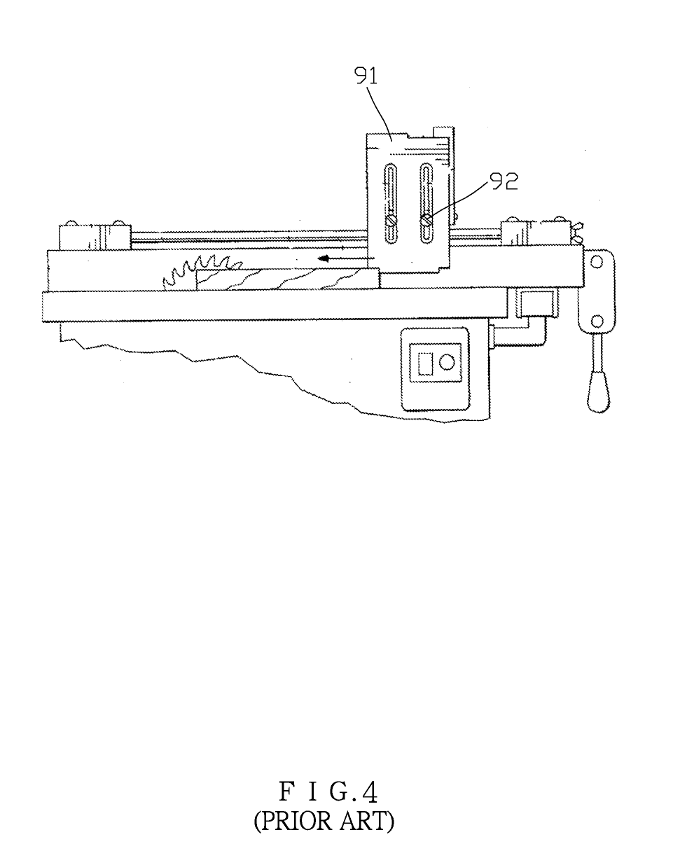

FIG. 5 is a perspective view showing the exploded components of a safe pushing device of table saws according to a preferred embodiment of the present invention;

FIG. 6 is a perspective view showing the assembly of the safe pushing device of the table saws according to the preferred embodiment of the present invention;

FIG. 7 is a cross sectional view showing the assembly of the safe pushing device of the table saws according to the preferred embodiment of the present invention;

FIG. 8 is a cross sectional view showing the operation of the safe pushing device of the table saws according to the preferred embodiment of the present invention;

FIG. 9 is another cross sectional view showing the operation of the safe pushing device of the table saws according to the preferred embodiment of the present invention;

FIG. 10 is a respective view showing the operation of the safe pushing device of the table saws according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

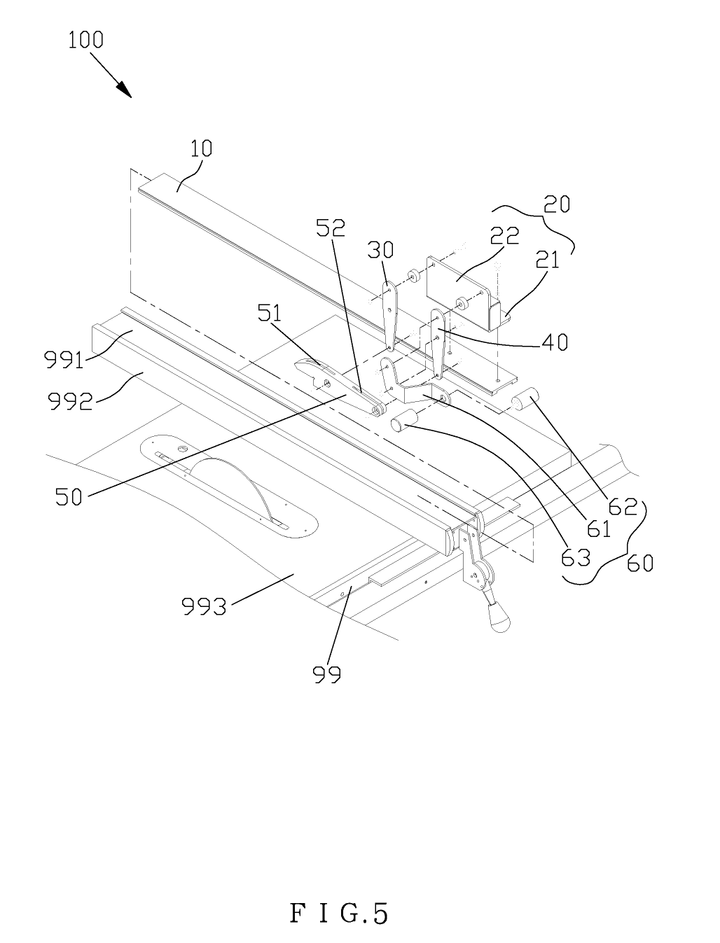

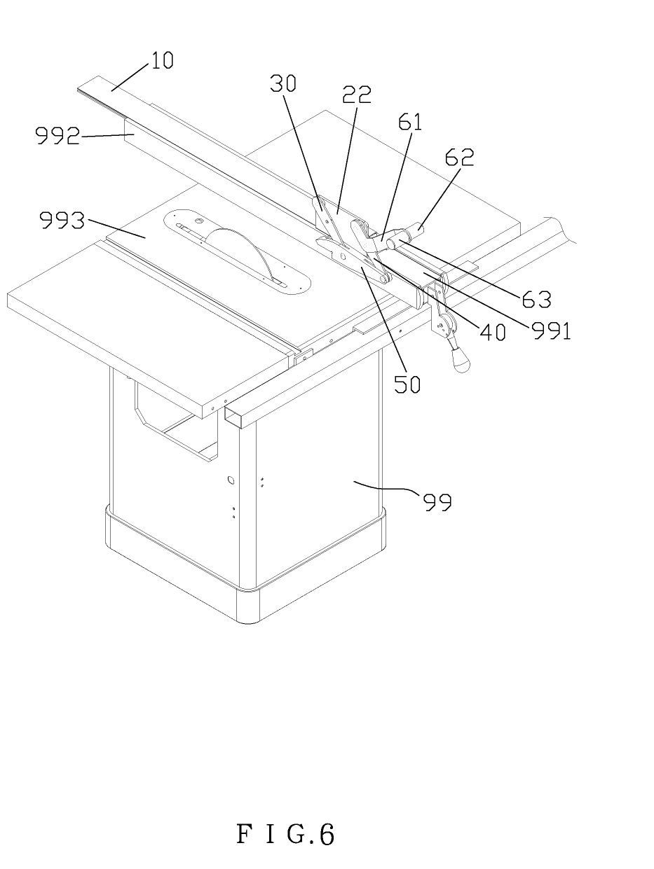

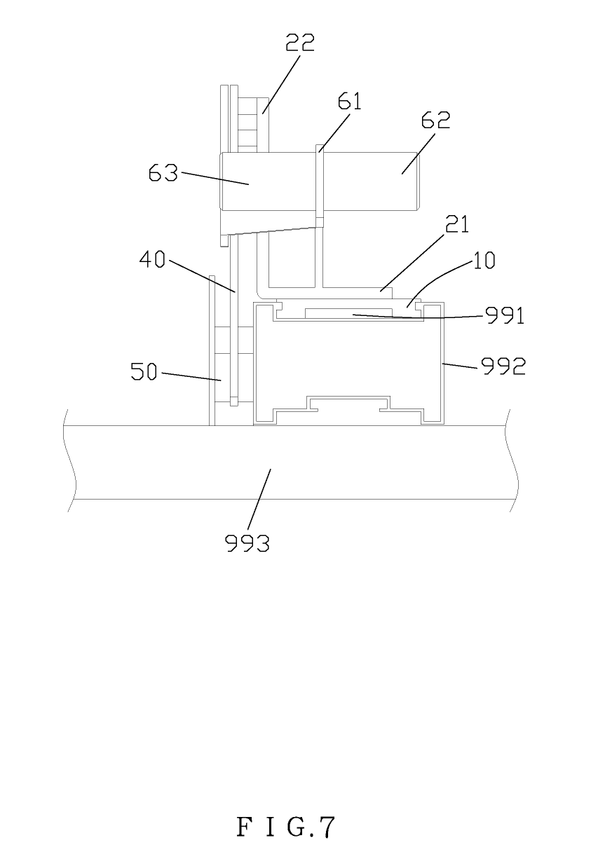

Referring to FIGS. 5-10, a safe pushing device 100 for table saws in accordance with a preferred embodiment of the present invention comprises a sliding member 10, a seat 20, a first axial arm 30, a second axial arm 40, a retaining member 50, and a handle member 60.

As shown in FIGS. 5-7, the sliding member 10 is an elongated plate and fitted into a guide way 991 of a fence 992 so as to be pushed to slide in the guide way 991 straightly.

As shown in FIGS. 5-7, the seat 20 is formed in a L shape and includes a bottom wall 21 fixed on the sliding member 10 and a side wall 22 connected with the bottom wall 21 and extending upward from one side of the bottom wall 21.

As shown in FIGS. 5-7, the first axial arm 30 includes one side face axially coupled with the side wall 22 of the seat 20.

As shown in FIGS. 5-7, the second axial arm 40 includes one side face axially connected with the side wall 22 of the seat 20, and spaced a predetermined distance apart from the first axial arm 30.

As shown in FIGS. 5-7, the retaining member 50 includes a first slot 51 and a second slot 52, both of which are arranged on a top end of the retaining member 50, to respectively insert and axially connect with free ends of the first and the second axial arms 30, 40.

As shown in FIGS. 5-7, the handle member 60 includes a support 61, a first bar 62, and a second bar 63, wherein one end of the support 61 is disposed on the second axial arm 40, the first and the second bars 62, 63 are fixed on two opposite edges of a free end of the support 61 to be held by a user.

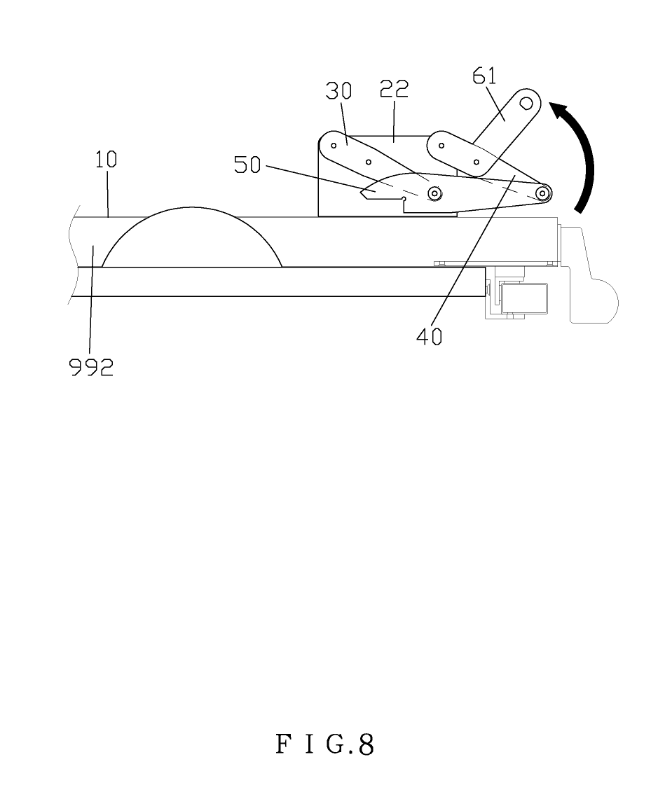

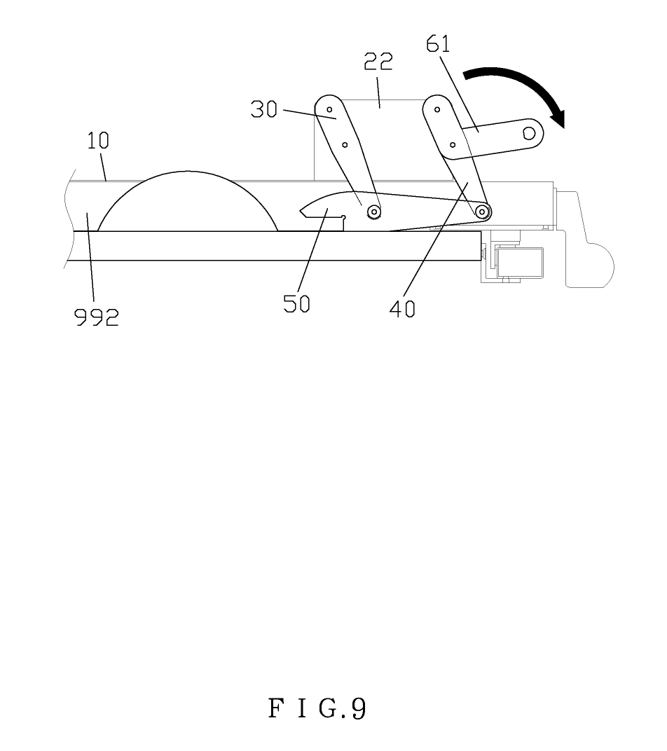

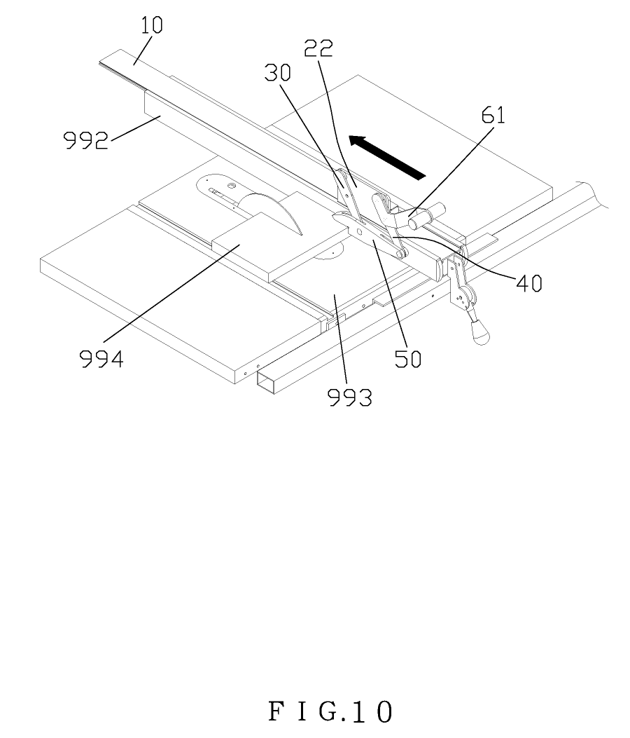

When desiring to cutting a wood workpiece 994, the first and the second bars 62, 63 of the handle member 60 are held, and the first and the second axial arms 30, 40 are pulled upward so as to swing upward and to actuate the retaining member 50 to displace upward as well (as illustrated in FIG. 8), hence the retaining member 50 is away a predetermined distance from a table plane 993 of a table saw 99, and then the wood workpiece 994 is placed on the table plane 993. Thereafter, the handle member 60 is held by the user to swing the first and the second axial arms 30, 40 downward (as shown in FIG. 9), and the retaining member 50 abuts against the wood workpiece 994, such that the sliding member 10 is forced to slide along the guide way 991 (as illustrated in FIG. 10) to have a cutting process.

Due to the safe pushing device is connected on the table saw without being removed, the safe pushing device for the table saw is capable of pushing the wood workpiece during a cutting process without using hands, thus obtaining a safety purpose.

Moreover, when retaining various workpieces with different thickness, the handle member is pulled upward to actuate the first and the second axial arms, and the retaining member to move upward, and then the handle member is moved downward to actuate the first and the second axial arms, and the retaining member to move downward without rotating screws and nuts tightly or releasably, thus operating easily.

While we have shown and described various embodiments in accordance with the present invention, it is clear to those skilled in the art that further embodiments may be made without departing from the scope of the present invention.

What is claimed is:

1. A safe pushing device for table saws comprising:
a sliding member fitted into a guide way of a fence so as to be pushed to slide in the guide way straightly;
a seat fixed on the sliding member;
a first axial arm including one side face axially coupled with the seat;
a second axial arm including one side face axially connected with the seat;
a retaining member axially connected with free ends of the first and the second axial arms;
a handle member disposed on the second axial arm.

2. The safe pushing device for the table saws claimed in claim 1, wherein the seat includes a bottom wall fixed on the sliding member and a side wall connected with the bottom wall and extending upward from one side of the bottom wall, the side wall of the seat axially connects with the first axial arm and the second axial arm, and the first and the second axial arms are spaced apart a predetermined distance from each other.

3. The safe pushing device for the table saws as claimed in claim 1, wherein the retaining member includes a first slot and a second slot, both of which are arranged on a top end of the retaining member, to respectively insert and axially connect with free ends of the first and the second axial arms.

4. The safe pushing device for the table saws as claimed in claim 1, wherein the handle member includes a support, a first bar, and a second bar, one end of the support is disposed on the second axial arm, the first and the second bars are fixed on two opposite edges of a free end of the support to be held by a user.
